(19) United States
(12) Patent Application Publication
(10) Pub. No.: US 2015/0062764 A1
(43) Pub. Date: Mar. 5, 2015

(54) ESD PROTECTION CIRCUIT

(71) Applicant: Kabushiki Kaisha Toshiba, Tokyo (JP)

(72) Inventors: Naoki WAKITA, Kanagawa-ken (JP); Mitsuhiro YANO, Tokyo (JP); Ryuji NISHIMOTO, Kanagawa-ken (JP); Katsuhiko MURATA, Kanagawa-ken (JP)

(73) Assignee: Kabushiki Kaisha Toshiba, Tokyo (JP)

(21) Appl. No.: 14/196,395

(22) Filed: Mar. 4, 2014

(30) Foreign Application Priority Data
Aug. 28, 2013 (JP) 2013-177168

(51) Int. Cl. H02H 9/02

(52) U.S. Cl. CPC H02H 9/02
USPC 361/57

(57) ABSTRACT

The ESD protection circuit includes a detection controlling circuit that is connected between the power supply line and the grounding line, detects a current flowing through the power supply line and outputs a controlling signal responsive to a result of the detection. The ESD protection circuit includes a protecting nMOS transistor connected to the power supply line at a drain thereof and receives the controlling signal at a gate thereof. The ESD protection circuit includes one stage of PN-junction diode connected to a source of the protecting nMOS transistor at an anode thereof and to the grounding line at a cathode thereof.

### CROSS-REFERENCE TO RELATED APPLICATION

This application is based upon and claims the benefit of priority from the prior Japanese Patent Application No. 2013-177168, filed on Aug. 28, 2013, the entire contents of which are incorporated herein by reference.

### BACKGROUND

1. Field

Embodiments described herein relate generally to an ESD protection circuit.

2. Background Art

There is an ESD protection circuit that protects an internal circuit connected between a power supply line and a grounding line from an ESD surge current. Such an ESD protection circuit detects an ESD surge current flowing through the power supply line and turns on a discharging MOSFET connected between the power supply line and the grounding line. Once turned on, the discharging MOSFET discharges the ESD surge current to the grounding line.

The discharging MOSFET is required to have a capability of discharging a large current in a short time. To meet this requirement, a large-area MOSFET is used as the discharging MOSFET. Such a discharging MOSFET is turned off in the normal operation. However, an off-leak current flows between the source and the drain.

### BRIEF DESCRIPTION OF THE DRAWINGS

FIG. 1 is a circuit diagram showing an example of a configuration of a semiconductor integrated circuit 1000 including an ESD protection circuit 100 according to a first embodiment;

FIG. 2 is a circuit diagram showing an example of a circuit configuration of the detection controlling circuit “DC” shown in FIG. 1;

FIG. 3 is a circuit diagram showing the semiconductor integrated circuit 1000 in which the diode “D” in the ESD protection circuit 100 shown in FIG. 1 is replaced with a PNP-type bipolar transistor;

FIG. 4 is a circuit diagram showing the semiconductor integrated circuit 1000 in which the diode “D” in the ESD protection circuit 100 shown in FIG. 1 is replaced with a pMOS transistor;

FIG. 5 is a diagram showing an example of a relationship between the leak current in the normal operation, the clamping voltage in the ESD operation and the circuit area for different gate lengths of the protecting nMOS transistor “Mn” of the ESD protection circuit 100 according to the first embodiment;

FIG. 6 is a characteristic diagram showing an example of current-voltage characteristics of the protecting nMOS transistor “Mn” for different substrate-source voltages;

FIG. 7 is a characteristic diagram showing an example of the current-voltage characteristics of the protecting nMOS transistor “Mn” for different gate lengths;

FIG. 8 is a circuit diagram showing an example of a configuration of a semiconductor integrated circuit 2000 including an ESD protection circuit 200 according to a second embodiment;

FIG. 9 is a circuit diagram showing the semiconductor integrated circuit 2000 in which the diode “D” in the ESD protection circuit 200 shown in FIG. 8 is replaced with an NPN-type bipolar transistor; and

FIG. 10 is a circuit diagram showing the semiconductor integrated circuit 2000 in which the diode “D” in the ESD protection circuit 200 shown in FIG. 8 is replaced with an nMOS transistor.

### DETAILED DESCRIPTION

An ESD protection circuit according to an embodiment protects an internal circuit connected between a power supply line connected to a power supply and a grounding line connected to a ground from a surge current flowing through the power supply line. The ESD protection circuit includes a detection controlling circuit that is connected between the power supply line and the grounding line, detects a current flowing through the power supply line and outputs a controlling signal responsive to a result of the detection. The ESD protection circuit includes a protecting nMOS transistor connected to the power supply line at a drain thereof and receives the controlling signal at a gate thereof. The ESD protection circuit includes one stage of PN-junction diode connected to a source of the protecting nMOS transistor at an anode thereof and to the grounding line at a cathode thereof. The detection controlling circuit outputs the controlling signal at a first control potential to the gate of the protecting nMOS transistor to turn on the protecting nMOS transistor in a case where the inclination of a voltage change caused by an increase of the current flowing through the power supply line with respect to time is equal to or greater than a prescribed value. The ESD protection circuit outputs the controlling signal at a second control potential lower than the first control potential to the gate of the protecting nMOS transistor to turn off the protecting nMOS transistor in a case where the inclination is smaller than the prescribed value.

In the following, embodiments will be described with reference to the drawings.

### First Embodiment

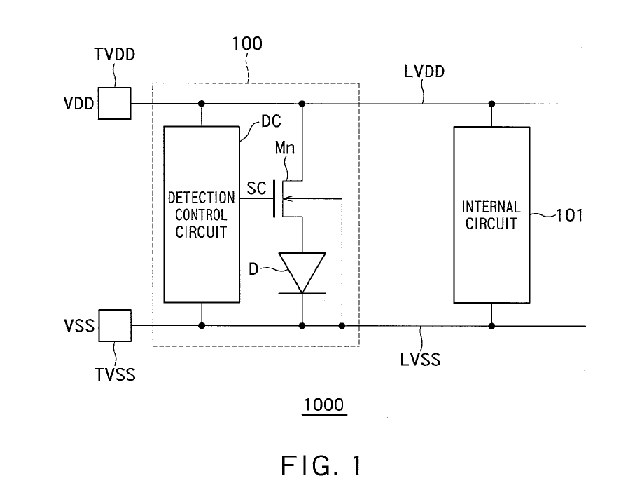

FIG. 1 is a circuit diagram showing an example of a configuration of a semiconductor integrated circuit 1000 including an ESD protection circuit 100 according to a first embodiment.

As shown in FIG. 1, the semiconductor integrated circuit 1000 includes the ESD protection circuit 100 and an internal circuit 101.

A power supply terminal “TVDD” is connected to a power supply that outputs a power supply voltage “VDD”.

A grounding terminal “TVSS” is connected to a ground that provides a ground voltage “VSS” (0 V).

The internal circuit 101 is connected between a power supply line “LVDD” connected to the power supply via the power supply terminal “TVDD” and a grounding line “LVSS” connected to the ground “VSS” via the grounding terminal “TVSS”. The internal circuit 101 is formed by a logic circuit, for example.

The ESD protection circuit 100 protects the internal circuit 101 from a surge current flowing through the power supply line “LVDD”.

As shown in FIG. 1, the ESD protection circuit 100 includes a detection controlling circuit “DC”, a protecting nMOS transistor “Mn”, and one PN-junction diode “D”, for example.

The protecting nMOS transistor “Mn” is connected to the power supply line “LVDD” at a drain thereof and to the grounding line “LVSS” at a back gate (substrate electrode) thereof and receives a controlling signal “SC” at a gate thereof.

The PN-junction diode “D” is connected to a source of the protecting nMOS transistor “Mn” at an anode thereof and to the grounding line “LVSS” at a cathode thereof. The PN-junction diode “D” has one PN junction.

In particular, as shown in FIG. 1, the anode of the PN-junction diode “D” is electrically connected to only the source of the protecting nMOS transistor “Mn”. Therefore, the magnitude of the current flowing to the source of the protecting nMOS transistor “Mn” is equal to the magnitude of the current flowing to the PN-junction diode “D”.

The detection controlling circuit “DC” is connected between the power supply line “LVDD” and the grounding line “LVSS”. The detection controlling circuit “DC” detects a voltage change caused by a change of the current flowing through the power supply line “LVDD” and outputs the controlling signal “SC” responsive to the result of the detection.

For example, in a case where the inclination of a voltage change caused by an increase of the current flowing through the power supply line “LVDD” with respect to time is equal to or greater than a prescribed value, the detection controlling circuit “DC” outputs the controlling signal “SC” at a first control potential (“High” level) to the gate of the protecting nMOS transistor “Mn” to turn on the protecting nMOS transistor “Mn”.

On the other hand, in a case where the inclination of a voltage change caused by an increase of the current flowing through the power supply line “LVDD” with respect to time is smaller than the prescribed value, the detection controlling circuit “DC” outputs the controlling signal “SC” at a second control potential (“Low” level) lower than the first control potential to the gate of the protecting nMOS transistor “Mn” to turn off the protecting nMOS transistor “Mn”.

The second control potential is the ground potential (0 V) of the grounding line “LVSS”, for example. In that case, when the controlling signal “SC” at the second control potential (“Low” level) is applied to the gate of the protecting nMOS transistor “Mn”, the voltage between the gate and the source of the protecting nMOS transistor “Mn” is negative by a forward voltage of the PN-junction diode “D”. That is, the protecting nMOS transistor “Mn” is turned off with reliability, and an off-leak current is prevented.

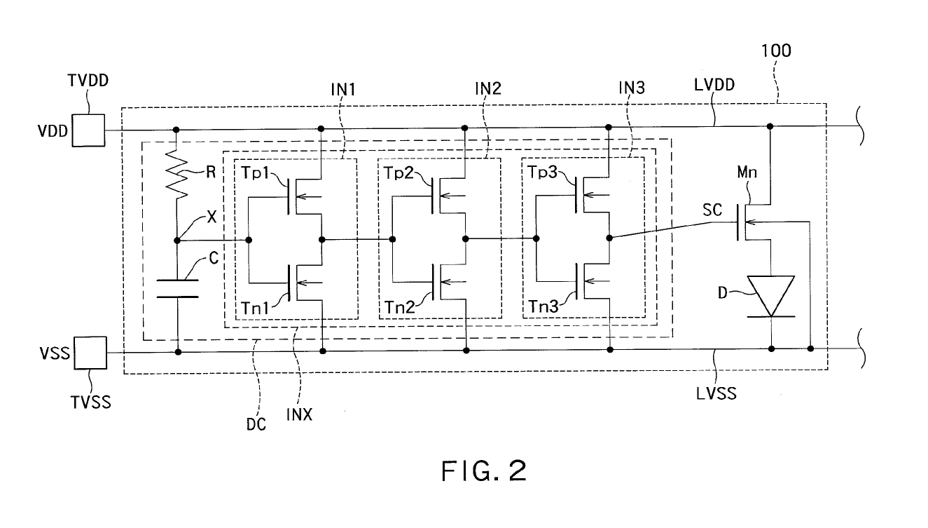

FIG. 2 is a circuit diagram showing an example of a circuit configuration of the detection controlling circuit “DC” shown in FIG. 1.

As shown in FIG. 2, the detection controlling circuit “DC” includes a resistive element “R”, a capacitive element “C”, and an inverter circuit “INX”, for example.

The resistive element “R” is connected to the power supply line “LVDD” at one end thereof.

The capacitive element “C” is connected to another end of the resistive element “R” at one end thereof and to the grounding line “LVSS” at another end thereof.

The inverter circuit “INX” is connected to a connection point “X” between the another end of the resistive element “R” and the one end of the capacitive element “C” at an input side thereof and outputs the controlling signal “SC” at an output side thereof. The inverter circuit “INX” shapes the waveform of a signal at the connection point “X” and outputs a signal obtained by inverting the logic of the shaped signal as the controlling signal “SC”.

The inverter circuit “INX” includes an odd number of (three, in the example shown in FIG. 2) stages of inverters “IN1”, “IN2” and “IN3”.

The inverter “IN1” has a controlling pMOS transistor “Tp1” and a controlling nMOS transistor “Tn1”.

The controlling pMOS transistor “Tp1” is connected to the power supply line “LVDD” at a source thereof, to an output of the inverter “IN1” (input of the inverter “IN2”) at a drain thereof, and to an input of the inverter “IN1” (connection point “X”) at a gate thereof.

The controlling nMOS transistor “Tn1” is connected to the grounding line “LVSS” at a source thereof, to the output of the inverter “IN1” (input of the inverter “IN2”) at a drain thereof, and to the input of the inverter “IN1” (connection point “X”) at a gate thereof.

The inverter “IN2” has a controlling pMOS transistor “Tp2” and a controlling nMOS transistor “Tn2”.

The controlling pMOS transistor “Tp2” is connected to the power supply line “LVDD” at a source thereof, to an output of the inverter “IN2” (input of the inverter “IN3”) at a drain thereof, and to an input of the inverter “IN2” (output of the inverter “IN1”) at a gate thereof.

The controlling nMOS transistor “Tn2” is connected to the grounding line “LVSS” at a source thereof, to the output of the inverter “IN2” (input of the inverter “IN3”) at a drain thereof, and to the input of the inverter “IN2” (output of the inverter “IN1”) at a gate thereof.

The inverter “IN3” has a controlling pMOS transistor “Tp3” and a controlling nMOS transistor “Tn3”.

The controlling pMOS transistor “Tp3” is connected to the power supply line “LVDD” at a source thereof, to an output of the inverter “IN3” (gate of the protecting nMOS transistor “Mn”) at a drain thereof, and to an input of the inverter “IN3” (output of the inverter “IN2”) at a gate thereof.

The controlling nMOS transistor “Tn3” is connected to the grounding line “LVSS” at a source thereof, to the output of the inverter “IN3” (gate of the protecting nMOS transistor “Mn”) at a drain thereof, and to the input of the inverter “IN3” (output of the inverter “IN2”) at a gate thereof.

Each of the controlling nMOS transistors “Tn1” to “Tn3” and the controlling pMOS transistors “Tp1” to “Tp3” is only required to have a driving capacity enough to output the controlling signal “SC”.

The driving capacity of the protecting nMOS transistor “Mn” described above to flow a current is set higher than the driving capacity of the controlling nMOS transistors “Tn1” to “Tn3” and the controlling pMOS transistors “Tp1” to “Tp3” to flow a current.

For example, the size (gate width) of the protecting nMOS transistor “Mn” is set larger than the size (gate width) of the controlling nMOS transistor.

In a normal operation, the detection controlling circuit “DC” configured as described above outputs the controlling signal “SC” at the second control potential to the gate of the protecting nMOS transistor “Mn”. As a result, the protecting nMOS transistor “Mn” is turned off.

When a current increase that causes a voltage change with respect to time having an inclination equal to or greater than the prescribed value occurs on the power supply line “LVDD” (a surge current flows through the power supply line “LVDD”), the potential at the connection point “X” changes, and the detection controlling circuit “DC” outputs the controlling signal “SC” at the first control potential to the gate of the protecting nMOS transistor “Mn”. As a result, the protecting nMOS transistor “Mn” is turned on.

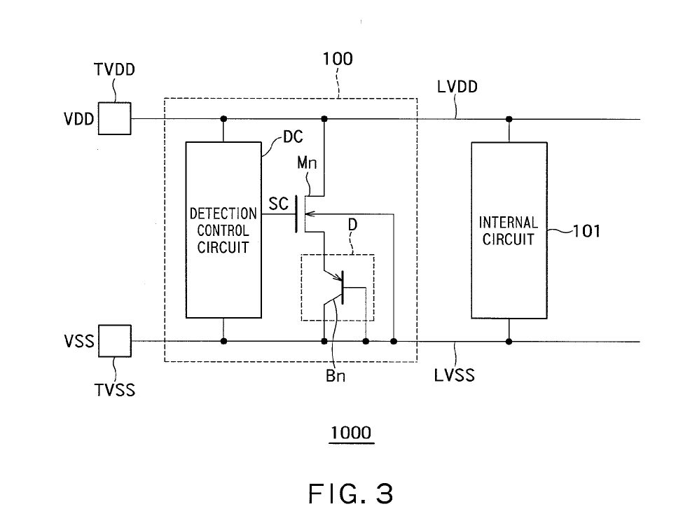

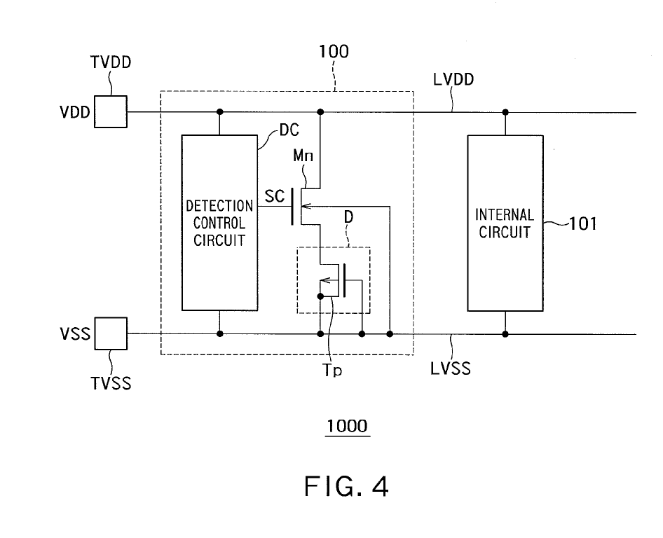

FIG. 3 is a circuit diagram showing the semiconductor integrated circuit 1000 in which the diode “D” in the ESD protection circuit 100 shown in FIG. 1 is replaced with a PNP-type bipolar transistor. FIG. 4 is a circuit diagram showing the semiconductor integrated circuit 1000 in which the diode “D” in the ESD protection circuit 100 shown in FIG. 1 is replaced with a pMOS transistor.

As shown in FIG. 3, the PN-junction diode “D” is a PNP-type bipolar transistor “Bn” that is diode-connected with an emitter thereof connected to the source of the protecting nMOS transistor “Mn” and a collector thereof and a base thereof connected to the grounding line “LVSS”, for example.

As an alternative, as shown in FIG. 4, the PN-junction diode “D” may be replaced with a pMOS transistor that is diode-connected with a source thereof connected to the source of the protecting nMOS transistor “Mn” and a drain thereof, a substrate electrode thereof and a gate thereof connected to the grounding line “LVSS”.

Next, an operational characteristic of the ESD protection circuit 100 configured as described above will be described.

As described above, in the case where the inclination of a voltage change caused by an increase of the current flowing through the power supply line “LVDD” with respect to time smaller than the prescribed value (that is, in the normal operation), the detection controlling circuit “DC” outputs the controlling signal “SC” at the second control potential (“Low” level) lower than the first control potential to the gate of the protecting nMOS transistor “Mn” to turn off the protecting nMOS transistor “Mn”.

In the normal operation, the gate voltage of the protecting nMOS transistor “Mn” is the second control potential (the ground voltage “VSS” (0 V)). Therefore, the potential difference between the gate and the source of the protecting nMOS transistor “Mn” with respect to the gate is −VS1. The voltage “VS1” is the potential difference across the PN junction of the diode “D” determined so that a leak current flowing through the nMOS transistor in the off state and the current flowing through the diode “D” agree with each other. Typically, the voltage “VS1” is equal to or lower than a threshold voltage of the diode “D”.

Therefore, the potential difference between the gate and the source of the protecting nMOS transistor “Mn” is negative. As a result, the leak current flowing through the protecting nMOS transistor “Mn” substantially decreases, and the power consumption of the ESD protection circuit 100 can be substantially reduced.

On the other hand, in the case where the inclination of a voltage change caused by an increase of the current flowing through the power supply line “LVDD” with respect to time is equal to or greater than the prescribed value (that is, in an ESD operation), the detection controlling circuit “DC” outputs the controlling signal “SC” at the first control potential (“High” level) to the gate of the protecting nMOS transistor “Mn” to turn on the protecting nMOS transistor “Mn”.

For a purpose thereof, the ESD operation is required to involve an operation of maintaining the potential of the power supply line “LVDD” connected to the drain terminal of the protecting nMOS transistor equal to or lower than a predetermined value.

However, insertion of the PN-junction diode “D” results in an increase of the source potential of the protecting nMOS transistor “Mn” by a voltage “VS2”.

The current flowing from the power supply line “LVDD” to the grounding line “LVSS” in the ESD operation is substantially greater than the leak current in the normal operation, and the voltage “VS2”> the voltage “VS1” (the voltage “VS2” is positive). The potential at the drain of the protecting nMOS transistor “Mn” increases by the potential increase “VS2”.

In the ESD operation, the protecting nMOS transistor “Mn” is in the on state, and the potential at the gate is substantially equal to the potential at the drain.

As a result, the potential difference between the gate and the source of the protecting nMOS transistor “Mn” is the drain voltage minus the voltage “VS2”, and the current driving power of the protecting nMOS transistor “Mn” decreases. As a result, the potential of the power supply line “LVDD” in the ESD operation increases by VS2+α (α denotes an increase of a clamping voltage caused by the decrease of the current driving power).

Therefore, a modification to increase the driving power of the protecting nMOS transistor “Mn” is effective. In general, increasing the driving power of the nMOS transistor leads to an increase of a leak in the normal operation.

However, the ESD protection circuit 100 provided with the PN-junction diode can increase the driving power of the protecting nMOS transistor “Mn” with little increase of the leak in the normal operation.

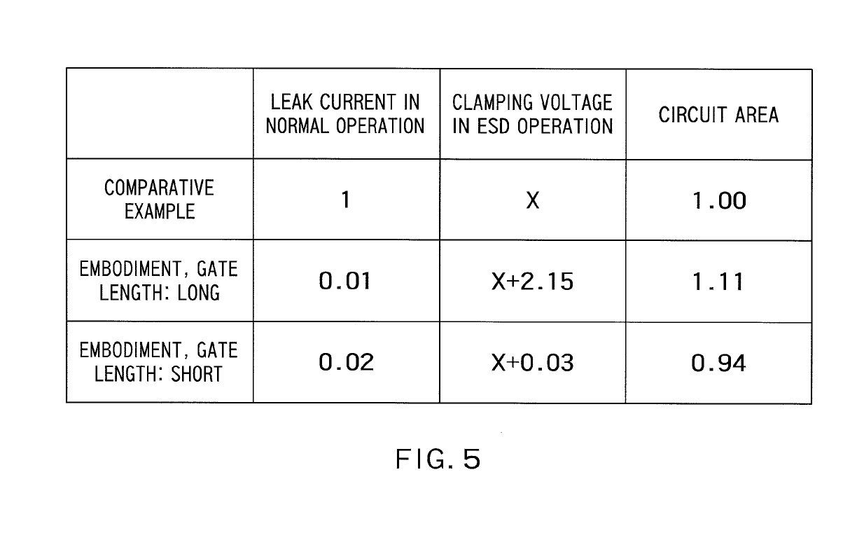

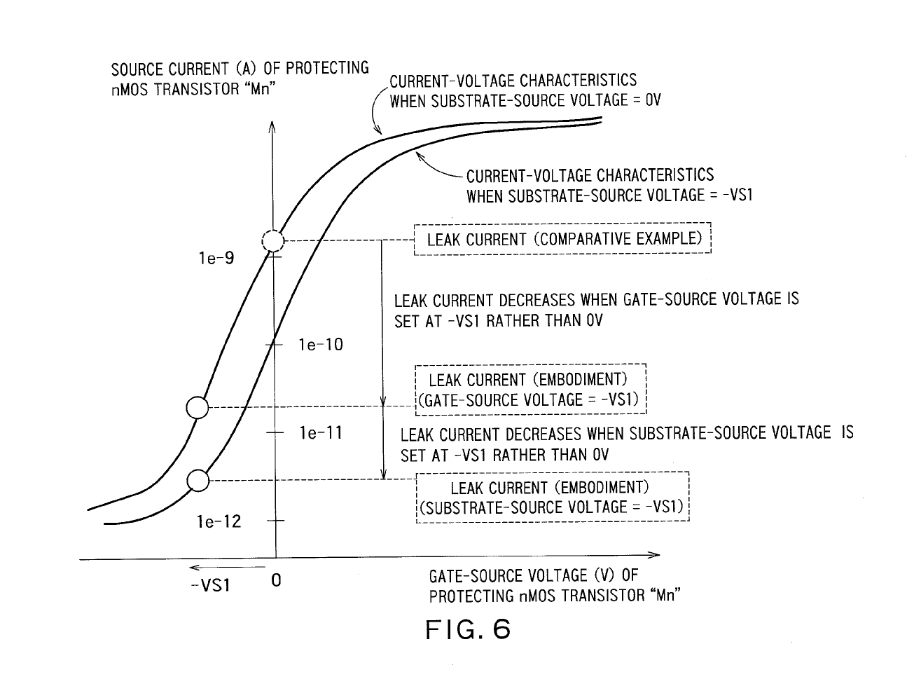

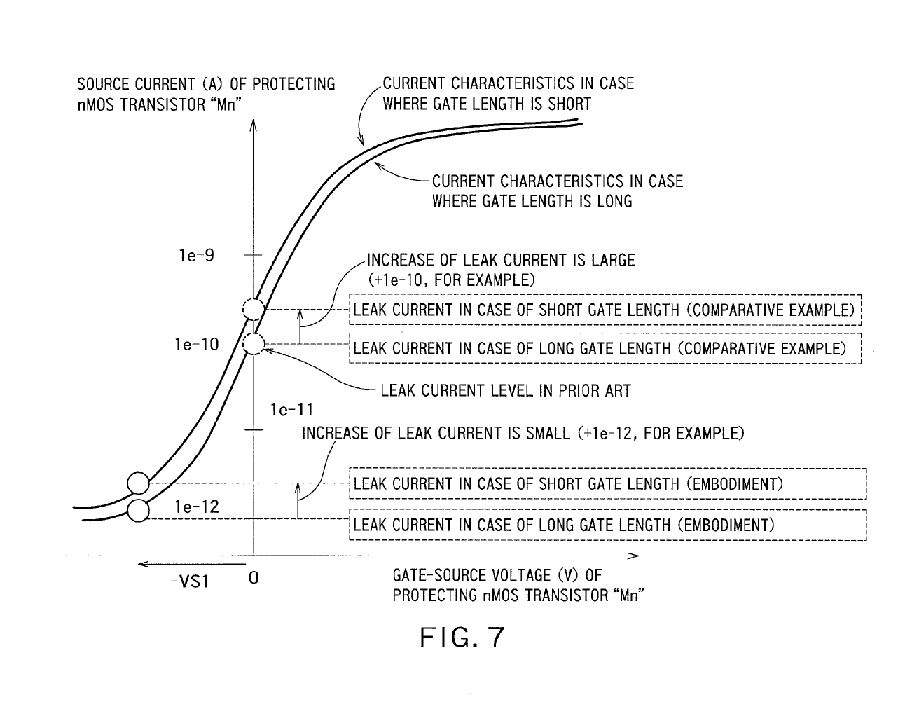

FIG. 5 is a diagram showing an example of a relationship between the leak current in the normal operation, the clamping voltage in the ESD operation and the circuit area for different gate lengths of the protecting nMOS transistor “Mn” of the ESD protection circuit 100 according to the first embodiment. FIG. 6 is a characteristic diagram showing an example of current-voltage characteristics of the protecting nMOS transistor “Mn” for different substrate-source voltages. FIG. 7 is a characteristic diagram showing an example of the current-voltage characteristics of the protecting nMOS transistor “Mn” for different gate lengths.

As shown in FIG. 7 by the dashed line circle, it is difficult to reduce the gate length of the protecting nMOS transistor “Mn” in the ESD protection circuit according to a comparative example (an arrangement with no PN-junction diode). This is because reducing the gate length leads to a substantial increase of the leak current in the normal operation (FIG. 7).

To the contrary, with the ESD protection circuit according to this embodiment, the PN-junction diode “D” is connected in the forward direction between the source of the protecting nMOS transistor “Mn” and the grounding line “LVSS”, so that the leak current in the normal operation is substantially reduced as described above (FIGS. 6 and 7).

In addition, as shown in FIG. 5, if the gate length of the protecting nMOS transistor “Mn” is reduced, the current driving power of the protecting nMOS transistor “Mn” increases, the potential of the power supply line “LVDD” in the ESD operation decreases, and the clamping voltage in the ESD operation can be changed to the same extent as in the comparative example.

In addition, with the ESD protection circuit 100 according to this embodiment, it is confirmed that the increase of the leak current in the case where the gate length is reduced is extremely small (FIG. 7).

That is, since the PN-junction diode “D” is connected in the forward direction between the source of the protecting nMOS transistor “Mn” and the grounding line “LVSS”, and the gate length of the protecting nMOS transistor “Mn” is reduced, the leak current in the normal operation can be substantially reduced without changing the potential of the power supply line “LVDD” (clamping voltage) in the ESD operation.

The increase of the circuit area due to the insertion of the PN-junction diode “D” can be cancelled by the decrease of the circuit area due to the reduction of the gate length of the protecting nMOS transistor “Mn”, which has a large area (FIG. 5).

In particular, as shown in FIG. 6, the leak current decreases because the gate-source voltage is set at −VS1 rather than the ground voltage (0V) and further decreases because the substrate-source voltage is set at −VS1 rather than the ground voltage (0V).

As described above, the ESD protection circuit according to the first embodiment can reduce the current consumption.

### Second Embodiment

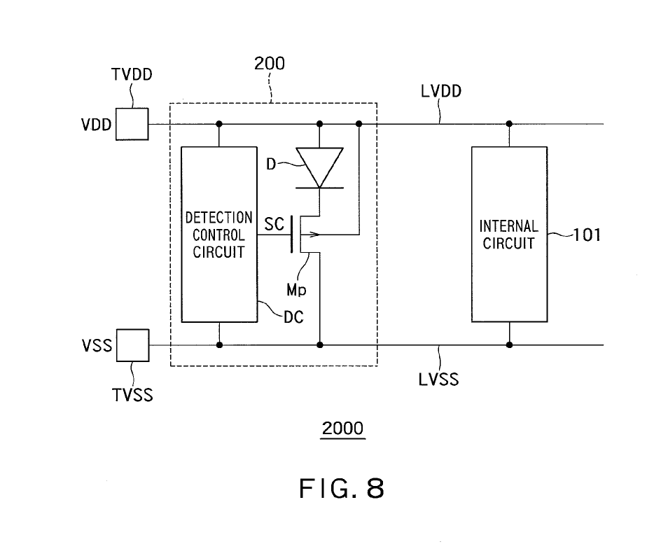

FIG. 8 is a circuit diagram showing an example of a configuration of a semiconductor integrated circuit 2000 including an ESD protection circuit 200 according to a second embodiment. In FIG. 8, the same reference numerals as those in FIG. 1 denote the same components as those in the first embodiment, and descriptions of those components will be omitted.

As shown in FIG. 8, the semiconductor integrated circuit 2000 includes the ESD protection circuit 200 and the internal circuit 101.

The ESD protection circuit 200 protects the internal circuit 101 from a surge current flowing through the power supply line “LVDD”.

As shown in FIG. 8, the ESD protection circuit 200 includes the detection controlling circuit “DC”, a protecting pMOS transistor “Mp”, and one stage of PN-junction diode “D”, for example.

The protecting pMOS transistor “Mp” is connected to the grounding line “LVSS” at a drain thereof and to the power supply line “LVDD” at a back gate (substrate electrode) thereof and receives the controlling signal “SC” at a gate thereof.

The PN-junction diode “D” is connected to the power supply line “LVDD” at an anode thereof and to a source of the protecting pMOS transistor “Mp” at a cathode thereof. The PN-junction diode “D” has one PN junction, as in the first embodiment.

In particular, as shown in FIG. 8, the cathode of the PN-junction diode “D” is electrically connected to only the source of the protecting pMOS transistor “Mp”. Therefore, the magnitude of the current flowing to the source of the protecting pMOS transistor “Mp” is equal to the magnitude of the current flowing to the PN-junction diode “D”.

The detection controlling circuit “DC” is connected between the power supply line “LVDD” and the grounding line “LVSS”. The detection controlling circuit “DC” detects a current flowing through the power supply line “LVDD” and outputs the controlling signal “SC” responsive to the result of the detection.

For example, in a case where the inclination of a voltage change caused by an increase of the current flowing through the power supply line “LVDD” with respect to time is equal to or greater than a prescribed value, the detection controlling circuit “DC” outputs the controlling signal “SC” at a first control potential (“Low level) to the gate of the protecting pMOS transistor “Mp” to turn on the protecting pMOS transistor “Mp”.

On the other hand, in a case where the inclination of a voltage change caused by an increase of the current flowing through the power supply line “LVDD” with respect to time is smaller than the prescribed value, the detection controlling circuit “DC” outputs the controlling signal “SC” at a second control potential (“High” level) higher than the first control potential to the gate of the protecting pMOS transistor “Mp” to turn off the protecting pMOS transistor “Mp”.

The second control potential is the power supply potential of the power supply line “LVDD”, for example. In that case, when the controlling signal “SC” at the second control potential (“High” level) is applied to the gate of the protecting pMOS transistor “Mp”, the voltage between the gate and the source of the protecting pMOS transistor “Mp” is positive by a forward voltage of the PN-junction diode “D”. That is, the protecting pMOS transistor “Mp” is turned off with reliability, and an off-leak current is prevented.

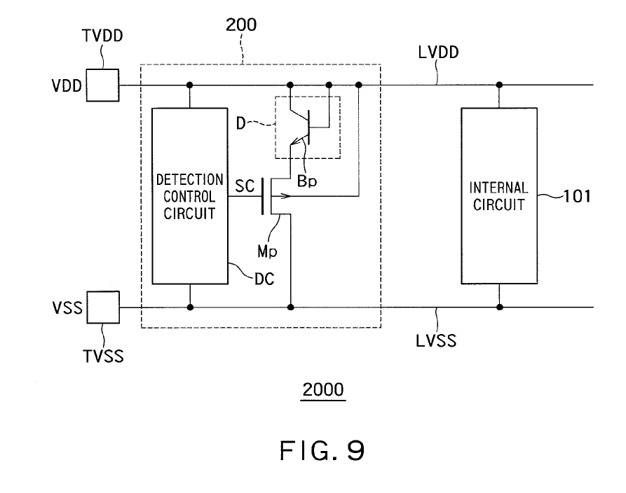

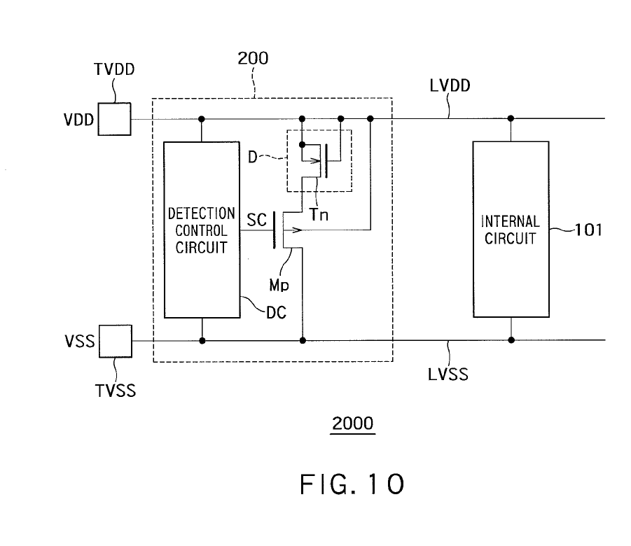

FIG. 9 is a circuit diagram showing the semiconductor integrated circuit 2000 in which the diode “D” in the ESD protection circuit 200 shown in FIG. 8 is replaced with an NPN-type bipolar transistor. FIG. 10 is a circuit diagram showing the semiconductor integrated circuit 2000 in which the diode “D” in the ESD protection circuit 200 shown in FIG. 8 is replaced with an nMOS transistor.

As shown in FIG. 9, the PN-junction diode “D” is an NPN-type bipolar transistor “Bp” that is diode-connected with an emitter thereof connected to the source of the protecting pMOS transistor “Mp” and a collector thereof connected to the power supply line “LVDD”, for example.

As an alternative, as shown in FIG. 10, the PN-junction diode “D” may be replaced with an nMOS transistor that is diode-connected with a source thereof connected to the source of the protecting pMOS transistor “Mp” and a drain thereof, a substrate electrode thereof and a gate thereof connected to the power supply line “LVDD”.

The remainder of the configuration of the ESD protection circuit 200 is the same as that of the ESD protection circuit 100 according to the first embodiment. The operation of the ESD protection circuit 200 is the same as that of the ESD protection circuit 100 according to the first embodiment.

That is, the ESD protection circuit according to the second embodiment can reduce the current consumption.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An ESD protection circuit that protects an internal circuit connected between a power supply line connected to a power supply and a grounding line connected to a ground from a surge current flowing through the power supply line, comprising:
a detection controlling circuit that is connected between the power supply line and the grounding line, detects a current flowing through the power supply line and outputs a controlling signal responsive to a result of the detection;
a protecting nMOS transistor connected to the power supply line at a drain thereof and receives the controlling signal at a gate thereof; and
one stage of PN-junction diode connected to a source of the protecting nMOS transistor at an anode thereof and to the grounding line at a cathode thereof,
wherein the detection controlling circuit
outputs the controlling signal at a first control potential to the gate of the protecting nMOS transistor to turn on the protecting nMOS transistor in a case where an inclination of a voltage change caused by an increase of the current flowing through the power supply line with respect to time is equal to or greater than a prescribed value, and
outputs the controlling signal at a second control potential lower than the first control potential to the gate of the protecting nMOS transistor to turn off the protecting nMOS transistor in a case where the inclination is smaller than the prescribed value.

2. The ESD protection circuit according to claim 1, wherein the magnitude of a current flowing to the protecting nMOS transistor is equal to the magnitude of a current flowing to the PN-junction diode.

3. The ESD protection circuit according to claim 1, wherein the anode of the PN-junction diode is electrically connected to only the source of the protecting nMOS transistor.

4. The ESD protection circuit according to claim 1, wherein the detection controlling circuit comprises a resistive element, a capacitive element and one or more stages of inverter circuits.

5. The ESD protection circuit according to claim 1, wherein the second control potential is a ground potential of the grounding line.

6. The ESD protection circuit according to claim 2, wherein the second control potential is a ground potential of the grounding line.

7. The ESD protection circuit according to claim 1, wherein the potential difference between the first control potential and the ground potential is greater than the absolute value of a forward voltage of the PN-junction diode.

8. The ESD protection circuit according to claim 2, wherein the potential difference between the first control potential and the ground potential is greater than the absolute value of a forward voltage of the PN-junction diode.

9. The ESD protection circuit according to claim 1, wherein the PN-junction diode is
a pMOS transistor that is diode-connected with a drain thereof connected to the source of the protecting nMOS transistor and a source thereof, a substrate electrode thereof and a gate thereof connected to the grounding line, or
a PNP-type bipolar transistor that is diode-connected with an emitter thereof connected to the source of the protecting nMOS transistor and a base thereof and a collector thereof connected to the grounding line.

10. The ESD protection circuit according to claim 2, wherein the PN-junction diode is
a pMOS transistor that is diode-connected with a drain thereof connected to the source of the protecting nMOS transistor and a source thereof, a substrate electrode thereof and a gate thereof connected to the grounding line, or
a PNP-type bipolar transistor that is diode-connected with an emitter thereof connected to the source of the protecting nMOS transistor and a base thereof and a collector thereof connected to the grounding line.

11. An ESD protection circuit that protects an internal circuit connected between a power supply line connected to a power supply and a grounding line connected to a ground from a surge current flowing through the power supply line, comprising:
a detection controlling circuit that is connected between the power supply line and the grounding line, detects a current flowing through the power supply line and outputs a controlling signal responsive to a result of the detection;
a protecting pMOS transistor connected to the grounding line at a drain thereof and receives the controlling signal at a gate thereof; and
one stage of PN-junction diode connected to a source of the protecting pMOS transistor at an anode thereof and to the power supply line at a cathode thereof,
wherein the detection controlling circuit
outputs the controlling signal at a first control potential to the gate of the protecting pMOS transistor to turn on the protecting pMOS transistor in a case where an inclination of a voltage change caused by an increase of the current flowing through the power supply line with respect to time is equal to or greater than a prescribed value, and
outputs the controlling signal at a second control potential lower than the first control potential to the gate of the protecting pMOS transistor to turn off the protecting pMOS transistor in a case where the inclination is smaller than the prescribed value.

12. The ESD protection circuit according to claim 11, wherein the magnitude of a current flowing to the protecting pMOS transistor is equal to the magnitude of a current flowing to the PN-junction diode.

13. The ESD protection circuit according to claim 11, wherein the cathode of the PN-junction diode is electrically connected to only the source of the protecting pMOS transistor.

14. The ESD protection circuit according to claim 11, wherein the detection controlling circuit comprises a resistive element, a capacitive element and one or more stages of inverter circuits.

15. The ESD protection circuit according to claim 11, wherein the second control potential is a potential of the power supply line.

16. The ESD protection circuit according to claim 12, wherein the second control potential is a potential of the power supply line.

17. The ESD protection circuit according to claim 11, wherein the potential difference between the first control potential and the potential of the power supply line is greater than the absolute value of a forward voltage of the PN-junction diode.

18. The ESD protection circuit according to claim 12, wherein the potential difference between the first control potential and the potential of the power supply line is greater than the absolute value of a forward voltage of the PN-junction diode.

19. The ESD protection circuit according to claim 11, wherein the PN-junction diode is
a nMOS transistor that is diode-connected with a drain thereof connected to the source of the protecting pMOS transistor and a source thereof, a substrate electrode thereof and a gate thereof connected to the power supply line, or
an NPN-type bipolar transistor that is diode-connected with an emitter thereof connected to the source of the protecting pMOS transistor and a base thereof and a collector thereof connected to the power supply line.

20. The ESD protection circuit according to claim 12, wherein the PN-junction diode is
a nMOS transistor that is diode-connected with a drain thereof connected to the source of the protecting pMOS transistor and a source thereof, a substrate electrode thereof and a gate thereof connected to the power supply line, or
an NPN-type bipolar transistor that is diode-connected with an emitter thereof connected to the source of the protecting pMOS transistor and a base thereof and a collector thereof connected to the power supply line.
